(19) United States
(12) Patent Application Publication
(10) Pub. No.: US 2019/0197568 A1
(43) Pub. Date: Jun. 27, 2019

(54) SEGMENTATION VIA WEATHER SUSCEPTIBILITY SCORING

(71) Applicant: International Business Machines Corporation, Armonk, NY (US)

(72) Inventors: HONGFEI LI, Briarcliff Manor, NY (US); TRAVIS R. PETERSEN, New York City, NY (US); ELISA B. VON MARSCHALL, Armonk, NY (US)

(21) Appl. No.: 15/850,409

(22) Filed: Dec. 21, 2017

(51) Int. Cl. G06Q 30/02

(52) U.S. Cl. CPC G06Q 30/0204

(57) ABSTRACT

A computer system implemented method for selectively responding to weather events includes receiving indicia of behaviors of persons for a weather event and determining a weather susceptibility score for the persons responsive to the indicia of behaviors for the weather event of the persons. Persons are classified into segments based on the weather susceptibility scores, such that the persons in respectively different ones of the segments have respectively different behaviors for the weather event and receives notification of the weather event. Responsive to the notification, a first one of the segments is selected, and a first action is initiated directed to the persons of a first one of the segments. The first action tends to affect the behaviors of the persons in the first one of the segments.

### BACKGROUND

Methods exist for segmenting customer data across industries. That is, there are some known ways to categorize customers according to the industries whose products or services they shop for and buy or otherwise consume, for example. Further, there are some known ways to categorize customers within an industry according to the geographic locations of the customers and according to climates associated with the respective locations.

### SUMMARY

In an embodiment of the present invention, a computer system implemented method for selectively responding to weather events includes the computer system receiving indicia of behaviors of persons for a weather event. The method includes determining, by the computer system, a weather susceptibility score for the persons responsive to the indicia of behaviors for the weather event of the persons. The computer system classifies the persons into segments based on the weather susceptibility scores, such that the persons in respectively different ones of the segments have respectively different behaviors for the weather event. The computer system receives notification of the weather event and selects a first one of the segments. The computer system initiates a first action directed to the persons of the first one of the segments, where the first action tends to affect the behaviors of the persons in the first one of the segments.

In other embodiments of the invention, other forms are provided, including a system and a computer program product.

### BRIEF DESCRIPTION OF THE DRAWINGS

Novel features believed characteristic of the invention are set forth in the appended claims. The invention itself, however, as well as a preferred mode of use, objectives and advantages thereof, will best be understood by reference to the following detailed description of an illustrative embodiment when read in conjunction with the accompanying drawings, wherein:

FIG. 1 depicts a cloud computing environment according to embodiments of the present invention.

FIG. 2 depicts abstraction model layers, according to embodiments of the present invention.

FIG. 3 illustrates a system 300 for weather drive-in customer segmentation and susceptibility scoring, according to embodiments of the present invention.

FIG. 4 illustrates further details of system 300, including modules and functions in the layers of system 300, according to embodiments of the present invention.

FIG. 5 illustrates details of scoring performed by system 300, according to embodiments of the present invention

FIG. 6 illustrates in a flow chart actions performed by one or more computer system processes, according to embodiments of the present invention.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and
Reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

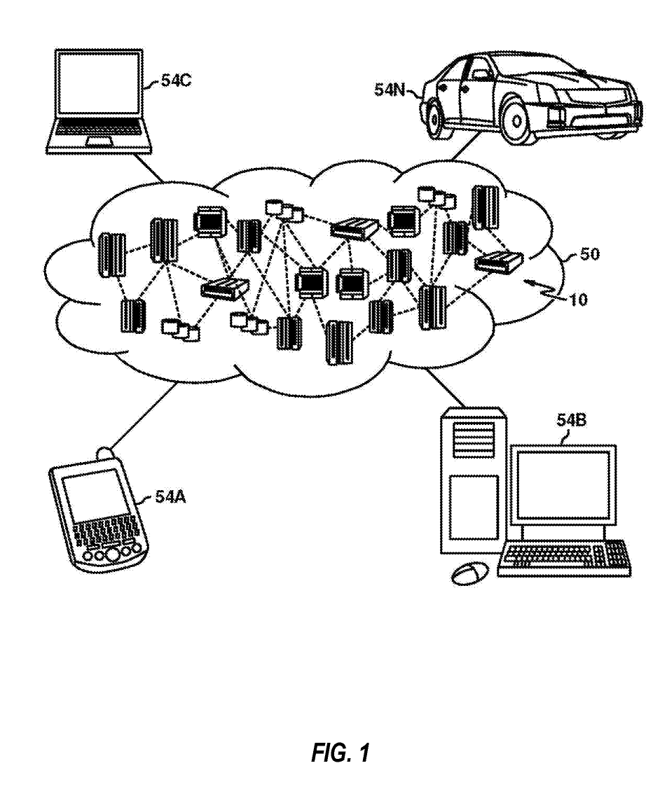

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices

54A-N shown in FIG. 1 are intended to be illustrative only and that computing nodes 10 and cloud computing environment 50 can communicate with any type of computerized device over any type of network and/or network addressable connection (e.g., using a web browser).

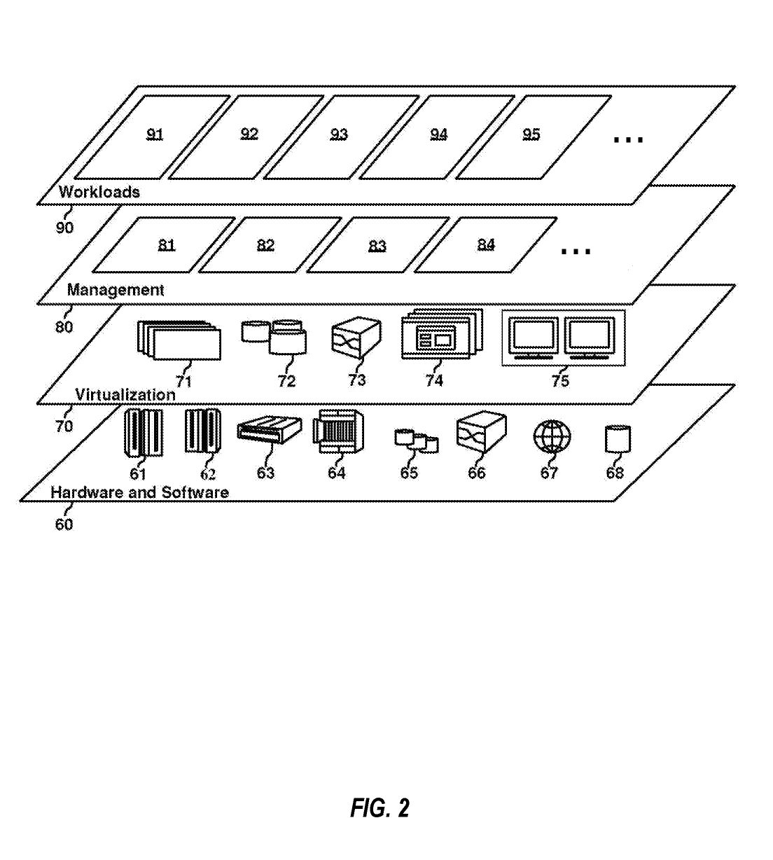

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:
Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.
Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.
In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.
Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95. The weather-driven customer segmentation and susceptibility scoring described herein may be included in data analytics processing 94 or transaction processing or both, for example.

In addition to known ways of segmentation described herein above, customers could be categorized within an industry according to the geographic locations of the customers and according to climates associated with the respective locations. Still further, the climate of a customer's location could suggest certain types of weather events may occur on average over a season and that such events could attract the customer's interest or affect the customer's sentiment or behavior. For example, an insurance company might use static demographic data and segmentation methods to determine groups likely to have more car accidents due to poor weather conditions, such as male drivers age 19-25 living in the Northeast United States, where snowstorms typically occur during a winter storm season.

Embodiments of the present invention provide even more specific ways for industries to dynamically segment their customers into groups (referred to herein as “weather susceptibility groups”) responsive to real time impact of weather on behavior, i.e., into groups in which customers in a group are influenced to behave in the same, specific way or ways in response to specific weather events, as the events occur. The groups are determined responsive to relevant, real time details about group members and events, which is not limited to static data, so that groups are accurate and relatively smaller than conventional, static segments, thereby making the groups suitable for more narrowly targeted communications.

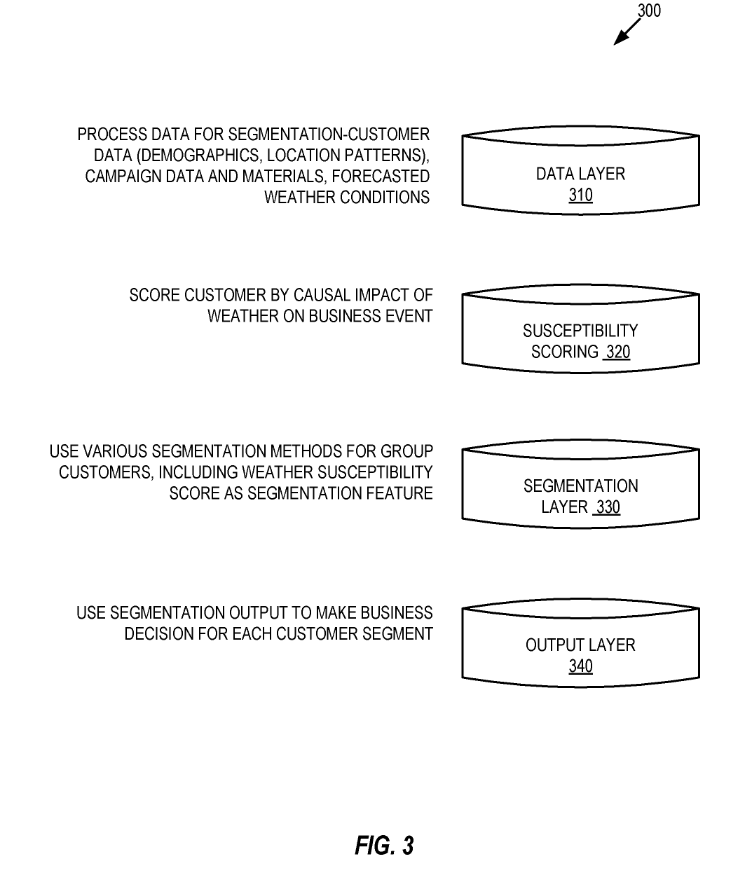

Referring now to FIG. 3, according to an embodiment of the present invention, a system 300 includes a data layer 310, a scoring layer 320, a segmentation layer 330 and an output layer 340. In general, data layer 310 includes data for model inputs, such as i) weather data, e.g., hourly, daily, weekly, monthly weather variables (temperature, precipitation, etc.), ii) customer data, e.g., demographics (gender, age, etc.) and behavioral attributes (mobility, medical, etc.), and iii) business data: any dependent variable that could be affected by weather. Scoring layer 320 includes an analytics engine that tests customer data against weather to determine weather's causal effect on a dependent variable to generate a weather susceptibility score. Segmentation layer 330 also includes an analytics engine and may be referred to also as a “segment and analytics” layer. Layer 330 creates customer segments across slices of available customer data including demographic, behavioral, and weather susceptibility scores. Output layer 340 includes customer segments rated by susceptibility to weather's impact on their value to the company, for example.

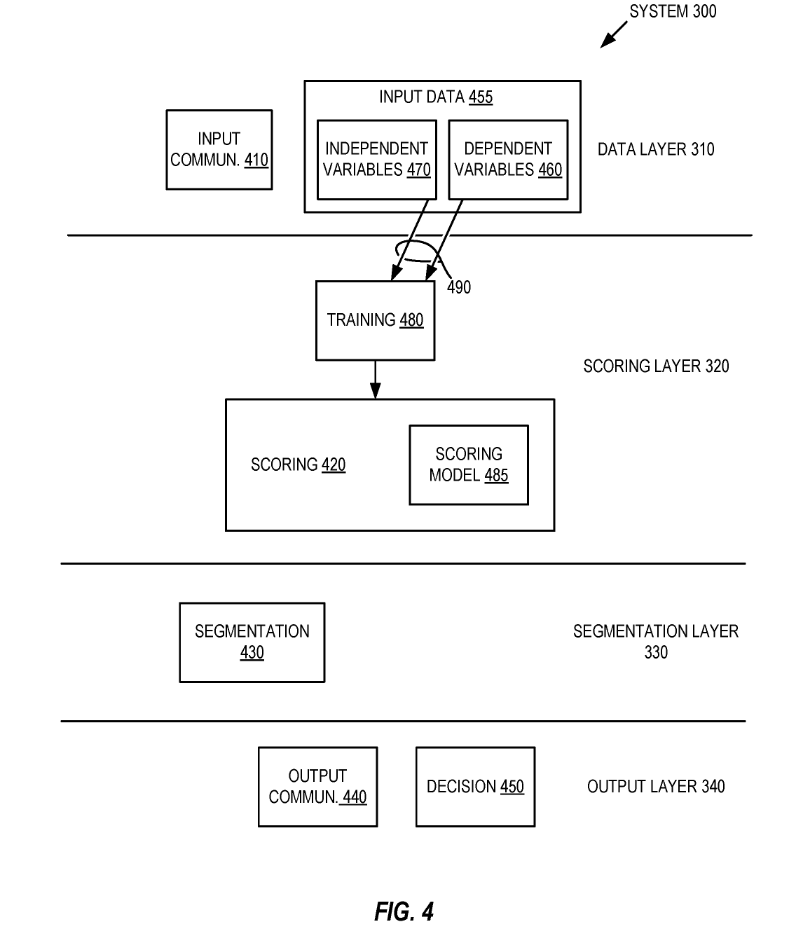

Referring now to FIG. 4, in connection with above described FIG. 3, further details of system 300 are illustrated, according to one or more embodiments of the present invention. System 300 includes a weather susceptibility scoring module 420 in scoring layer 320 that determines weather susceptibility scores for customer populations responsive to potential weather conditions and attributes of customers in the population, where such a score indicates the susceptibility of customers to exhibiting a predetermined behavior in response to an actual weather condition, and where the behavior is of interest to a particular business.

Segmentation layer 330 of system 300 includes a segmentation module 430. In response to receiving scores computed by weather susceptibility scoring module 420, segmentation module 430 groups customers according to their weather susceptibility scores.

This way of grouping may be applied to a variety of industries and customer behaviors, such as, for example, the insurance industry. Output layer 340 of system 300 includes an output communication module 440. Using the insurance industry example, automobile accidents may be automatically reduced by communication module 440 receiving from segmentation module 430 a list of existing customers in an at-risk segment of customers and weather susceptibility scores of those at-risk customers for predetermined weather conditions. Input communication module 410 in data layer 310 also receives the specified weather conditions and then monitors for impending weather events corresponding to those specified, i.e., predetermined, weather conditions. In response to detecting such an impending weather event, i.e., indicated by the specified weather conditions, relevant to the listed customers in the at-risk segment, module 410 automatically notifies output communication module 440 to send weather event warnings to the listed customers, which module 440 may do by SMS or email messages, for example.

Insurance rates may even be adjusted responsive to impending weather events. That is, in one or more embodiments weather susceptibility scoring module 420 determines weather susceptibility scores for prospective customers in a similar fashion as described above for existing customers. Segmentation module 430 may then group the prospective customers according to their weather susceptibility scores.

System 300 may include a decision module 450 that receives from segmentation module 430 the categories, i.e., groups, of prospective customers and/or weather susceptibility scores of those customers that are based on specified weather conditions. Input communication module 410 checks for impending weather events corresponding to those predetermined weather conditions and passes notifications of those events to decision module 450, which responsively, automatically increases potential rates for those prospective customers in response to detecting such an impending weather event relevant to the listed customers, for example.

In one or more embodiments, decision module 450 receives from segmentation module 430 the categories, i.e., groups, of existing customers and/or weather susceptibility scores of those customers. Upon input communication module 410 determining that there are no impending weather events for a particular time of year corresponding to those predetermined weather conditions, input communication module 410 notifies decision module 450 of this. Decision module 450 then automatically and responsively reduces rates for existing customers who would otherwise have higher rates due to previously anticipated weather conditions and their weather susceptibility scores, for example.

These and other examples are set out in Table One herein below.

TABLE ONE

| | Business Event | Feature Selection | Customer Segments | Bus. Decisions | Contextual Analysis |
|---|---|---|---|---|---|
| Industry | Data layer | Analytics layer | Analytics layer | Output layer | Output layer |
| Insurance | Automobile Accidents | Precipitation, Temperature, | Those who don't drive at | Alerts, Insurance | Target alert campaigns to |
| | | Visibility, Driver Age, | night, those whose work | rate setting | specific segments in |
| | | Demographics | requires them to drive | | advance of forecasted |
| | | | in rain (food delivery when | | weather events |
| | | | take- out orders spike) | | |
| Healthcare | Emergency Room Mgmt | Precipitation, Temperature, | Patient segments (asthma | Make healthcare | Increase staffing levels |
| | | Pressure, Patient History | patients, arthritis patients, | decisions to improve | and pharmaceutical needs |
| | | | automobile accidents) | efficiency of hospital | in response to patient |
| | | | | | segments most impacted by |
| | | | | | different weather events |
| Restaurant | Meal Delivery | Precipitation, Snow, | Those more likely to cook | Food supply chain and | Understanding and serving |
| and Food | | Customer Age, Demographic | at home given a severe | staffing mgmt | needs to clients |
| Services | | Data | thunderstorm or those | | effectively could increase |
| | | | likely to order take | | revenue during otherwise |
| | | | out/delivery | | slow events |

It should be appreciated from the foregoing that causal impact of weather on persons related to a business event are utilized to analyze how different customers are affected by the weather. Specifically, analysis described herein identifies those customer segments most and least affected by certain dynamic weather patterns, such as snowstorms, thunderstorms, etc. This empowers businesses to mitigate and address categories of customers who may be negatively affected by weather, for example. And businesses may encourage similar behavior among the segments of customers who are not affected by weather through promotions or discounts, for example. It allows businesses to effectively focus their targeted campaigns and decisions, reducing costs and improving campaign metrics.

Using the insurance business example, a discrete dependent variable 460 received by scoring model 485 may include, for example, occurrence (or not) of an accident during a certain period of time, such as a certain six-month period, according to embodiments of the present invention. Alternatively, the accident/no accident, independent variable may be or may include, for example, classes of accidents, such as bodily injury/no bodily injury, property damage ranging from $0 to $50,000, from $50,000 to $100,000, and above $100,000, etc. Still further, the independent variable may be continuous, such as dollar amount of property damage, dollar amount of total liability, etc.

Independent variables 470 in data layer 310 include variables in the categories of weather-related and customer-related, for example. Examples of weather-related independent variables may include temperature, barometric pressure, humidity, wind speed, precipitation, visibility, etc. The customer-related variables are in the categories of demographic-related and behavioral-related. Examples of demographic-related independent variables may include gender, age, home-owner, salary, years of education, profession, etc. Examples of behavioral-related independent variables may include whether driving includes night-time driving, whether driving includes driving for work, time since last reported accident, time since last reported claim, etc.

Data layer 310 of system 300 includes an input data module 455 and scoring layer 320 includes a training module 480, which receives 490 a set of training data from input data module 455. Each record in training data provides a set of observations for a known outcome, which may be considered a dependent variable 460. For example, an observation set includes historical observations for a variable 460 indicating an accident either did or did not occur during a predetermined time period (or indicating how many accidents occurred) and includes corresponding values of weather-related, demographic-related and behavioral-related independent variables 470 for the known instance of accident/no accident/how many accidents, in at least one embodiment of the present invention. System 300 includes a scoring model 485 in weather susceptibility scoring module 420. Training module 480 uses received 490 training data 460 and 470 of data layer 310 to train scoring model 485, i.e., to derive parameters such as coefficients, where model 485 may be of a known type, such as, for example, a naïve Bayes model, a decision tree model, a linear regression model, etc.

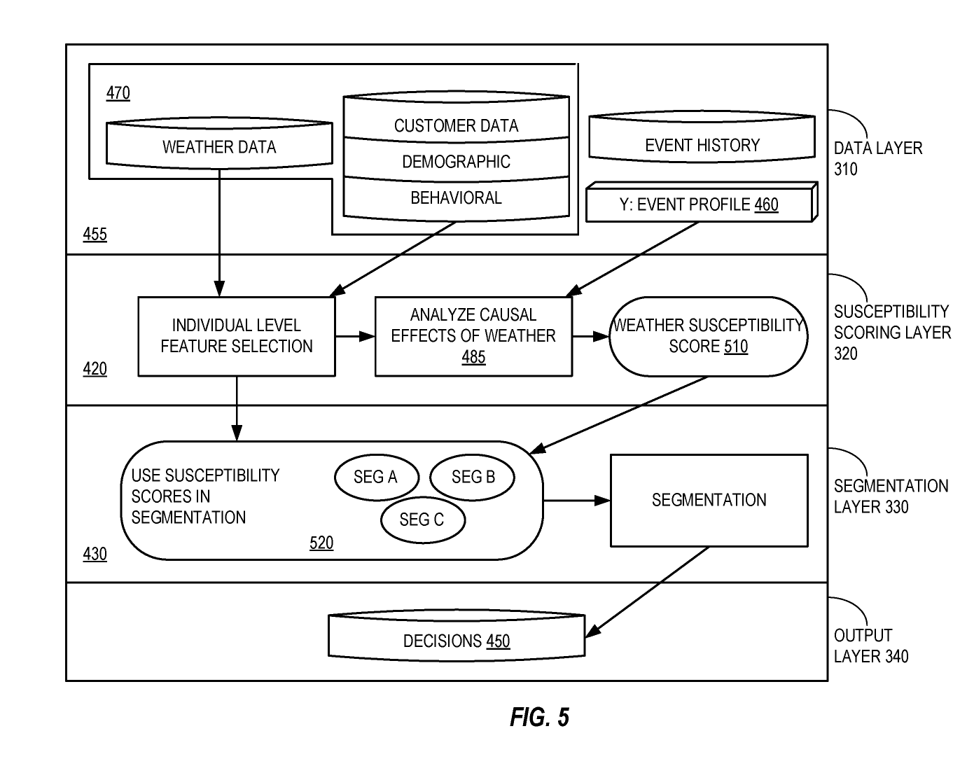

FIG. 5 illustrates further aspects of system 300, according to embodiments of the present invention. Continuing with the accident example, once scoring model 485 has been trained, weather susceptibility scoring module 420 applies received 490 independent variables 470 to scoring model 485 as input data 455. Model 485 responsively outputs a score as predicted, dependent variable 460, where the score indicates susceptibility to occurrence of an accident as a function of the received 490 independent variables 470. For example, a higher score may indicate a greater tendency for occurrence of an accident, which may be from training based on known, discrete instances (accident/no accident/how many accidents) for dependent variables 460 and observations of corresponding independent variables 470. In another example, a higher score may indicate a prediction for a higher dollar amount of damage or a greater tendency for a higher dollar amount of damage, etc., which may be from training based on known, discrete instances of damages for dependent variables 460 and observations of corresponding independent variables 470. Alternatively, a lower score may indicate a higher tendency for occurrence of an accident, higher dollar amount, etc.

In the asthma example of Table One, a dependent variable 460 score may be for occurrence (or not) of an asthma attack within a certain period of time, for example. There may be other alternatives, such as asthma attacks of a certain type in the period or some measure of respiratory capacity in particular instances, for example.

In general, a user initially selects features to include as independent variables, i.e., weather-related, demographic-related and behavioral-related in the example, based on their presumed effect on dependent variable(s) 460 to be predicted, where the predicted effect is indicated as weather susceptibility score(s). Also, a user selects a model type for scoring model 485 in weather susceptibility scoring module 420, which may be based on the user's assumptions about how independent variables 470 are related to the dependent variable(s) 460. Parameters of model 485 are derived by training, as described above. In individual level feature selection, the user may adjust independent variable 470 selections (and even and model 485 type selections) based on statistical analysis of training results until a satisfactory set of independent variables (input data) and model type are established. An objective is to influence targeted outcomes. Different variable 470 selections may reveal dependencies between a desired outcome and weather events, personal attributes and/or personal behavior.

Once the configuration of model 485 and input data 460 and 470 selections are sufficiently established via training, input data module 455 provides to model 485 sets of independent variable 470 values for customers, and model 485 responsively outputs weather susceptibility scores 510 for the customers. (Data for two sets of customers may be involved in the processing described—one set of customers for training model 485 and one set for whom the model 485 produces scores. That is, behavioral-related inputs and outcomes, such as accident/no accident/how many accidents in the insurance example above, of a first set of customers may be used in training model 485, whereas the trained model 485 may generate scores for a second set of customers. Typically, none of the customers in the second set are in the first set. However, a customer may be in both sets where a score is generated for the customer based on independent variable observations regarding the customer that are different than observations regarding the customer that were used for the training. For example, the data used by model 485 for generating the score may be more recent than the data used for training the model 485.)

Once weather susceptibility scores 510 are generated for the respective customers, segmentation module 430 may then group the customers according to their scores. To do this, a segmentation module 430 may include another model 520, which may be referred to as a “segmentation model” 520, where model 520 receives weather and customer data and also receives the customers weather susceptibility scores 510 from weather susceptibility scoring model 485 as independent variables. Once trained or otherwise configured, model 520 responsively outputs classifications for the scores 510 based on the scores and other variables received. Table Two below shows an example in which the illustrated ones of the scores 510 generated by weather susceptibility scoring model 485 range from 0.4 to 4.9, and segmentation model 520 has classified the scores (and associated customers) in three classes, i.e., segments A, B and C. Segment A includes only the scores at the low end of the range, segment B includes only the mid-range scores and segment C includes only the higher scores.

TABLE TWO

| | | | | | | Weather Data | | | | | |
|---|---|---|---|---|---|---|---|---|---|---|---|
| Customer Data | | | | | | | | | | Weather Event | Cstmr |
| Behavioral | | | Demographic | | | Event | Precipitation | . . . | Temperature | Suscept. Score | Segment |
| x_event1 | . . . | x_k1 | x_age1 | . . . | x_j1 | x_storm1 | x_precip1 | . . . | x_temp1 | 0.8 | B |
| x_event2 | . . . | x_k2 | x_age2 | . . . | x_j2 | x_storm2 | x_precip2 | . . . | x_temp2 | 1.3 | C |
| x_event3 | . . . | x_k3 | x_age3 | . . . | x_j3 | x_storm3 | x_precip3 | . . . | x_temp3 | 0.4 | A |
| . . . | . . . | . . . | . . . | . . . | . . . | . . . | . . . | . . . | . . . | . . . | . . . |
| x_eventn | . . . | x_kn | x_agen | . . . | x_jn | x_stormn | x_precipn | . . . | x_tempn | 4.9 | C |

Segmentation model 520 may be of a known type, such as, for example, tree-based model, k-means clustering, factor segmentation, etc. As with scoring model 485, a user selects a model type for segmentation model 520, which may be based on the user's assumptions about how the independent variables (scores) are related to the dependent variable (segments). As also with scoring model 485, parameters such as coefficients of segmentation model 520 may be derived by training, as described above, and the user may adjust the user's selection of model type based on statistical analysis of training results, as is well-known, until a satisfactory type is established.

As can be seen from the above example, segmentation model 520 determines ranges of the weather susceptibility scores for each segment. Model 520 may also determine the number of segments. Alternatively, the number of segments may be predetermined. That is, for example, a user may specify the number of segments as an independent variable for input to model 520.

As indicated above, segmentation model 520 may receive other inputs, besides the scores, including, for example, demographic and behavioral customer data 470.

The way segmentation model 520 determines ranges of the weather susceptibility scores for each segment is dependent on what type of model the user selects for segmentation model 520. For example, model 520 may use a decision tree method, where model 520 automatically determines ranges by information gain. Model 520 may use a clustering method, such as k-means clustering which groups segmentation scores differently. The number of segments also depends on the model used. For example, an optimal number of clusters may be determined using an automated selection algorithm (such as the elbow-method in k-means).

In contrast to prior art, embodiments of the present invention use dynamic weather events for customer segmentation, not merely climate data for the geographic location of user. Rather than combining various existing segmentation method scores, the processes described herein generate a new segmentation score. This score may ultimately be combined with other scores.

In embodiments of the present invention, system 300 does not merely segment based on customer interaction with a previous campaign (“campaign susceptibility,” in a phrase). Rather, system 300 considers weather via a weather susceptibility score. Also, embodiments relate customer behavior that does not necessarily appear to be directly weather related to dynamic, external weather factors. This goes beyond creating segments based on customer behavior that is directly observable as weather related. Checking a weather application via cell phone is an example of customer behavior that is directly observable as weather related, as is selecting a method of transportation (walking vs. driving). Examples of customer behavior that does not necessarily appear to be directly weather related to weather include checking email and going to work.

Rather than using weather situational factors to determine which behavior customers will exhibit, system 300 determines how weather affects customer segmentations.

Although the term “customer” is used herein, the segmentation, prediction, etc. described herein may also apply to persons who are merely prospective customers and even to persons in a context that does not involve a purely commercial transaction. Therefore, use of the term “customer” herein should not be considered limiting unless explicitly indicted.

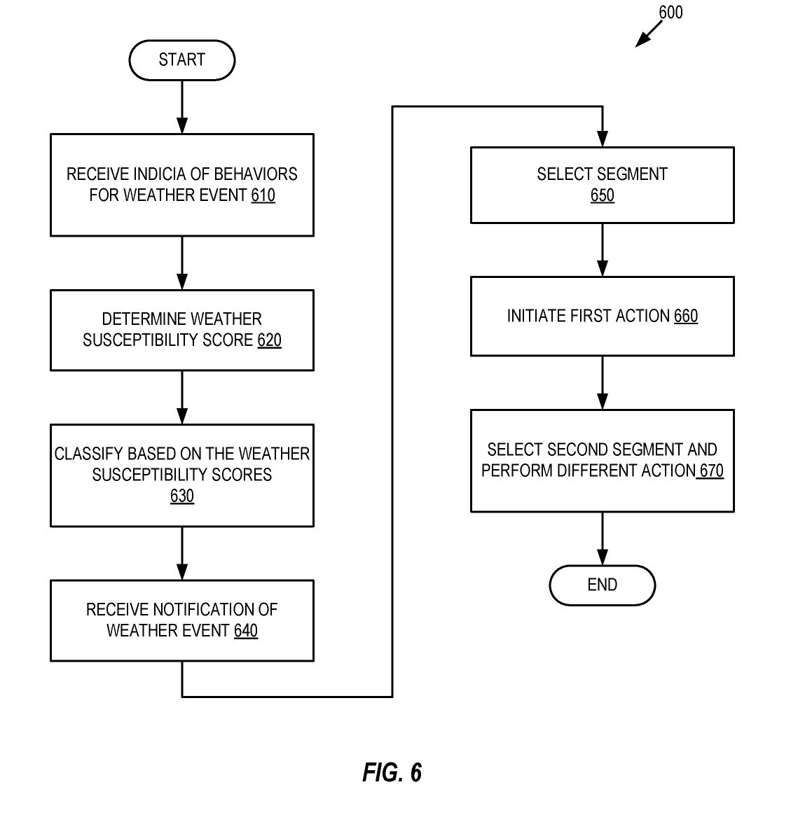

Referring now to FIG. 6, a computer system implemented method 600 of selectively responding to weather events is illustrated in a flow chart, according to an embodiment of the present invention. At 610, the computer system receives indicia of weather-related behaviors of persons for a weather event. Indicia of behaviors of persons for a weather event may include attributes of persons that tend to indicate behaviors of the persons for the weather event. (The term “weather event” may encompass one or more weather conditions associated with, or tending to be associated with, a weather-related event, such as temperature, humidity, precipitation, etc.)

Examples of personal attributes that may tend to indicate weather-related behaviors include:
In the context of controlling automobile insurance claims and/or reducing claims by notifying certain drivers of weather event causing low visibility condition, personal attributes may include drivers with poor night vision and day driving jobs. Poor night vision, for example, may be a personal attribute that is useful as an independent variable to indicate a behavior of driving avoidance for weather events associated with low visibility of roads, a weather-related behavior that may be predicted by the weather susceptibility scoring model.
In the context of controlling emergency room and/or increasing staff due to certain precipitation, temperature and/or barometric pressure conditions, which are weather event(s), a personal attribute may include having asthma, which may be associated with increased tendency in the behavior of seeking ER services.
In the context of controlling food delivery and/or increasing staff due to icy conditions, extreme cold, or low visibility, which are weather event(s), personal attributes may include presence of a customer in the geographical area of the weather event(s), which may be associated with the behavior of tending to stay home during such event(s)
The received indicia may also include observations of behaviors of the persons for the weather event. The above examples of behavior related to a weather event may be received as observations for a variable of the model.

At process 620, the computer system determines a weather susceptibility score for the persons. The score is responsive to the indicia of behaviors for the weather event of the persons. The computer system classifies persons into segments at process 630 based on the weather susceptibility scores. For example, this may include classifying such that each of the persons are in only one of the segments. Persons in respectively different ones of the segments have respectively different behaviors for the weather event. Respectively different behaviors of the persons in respectively different ones of the segments may include respectively different degrees of the same behaviors.

Next at 640 the computer system receives notification of the weather event, which may be notification of a predicted occurrence or a present occurrence. At 650 the computer system selects a first one of the segments. For example, this may include selecting the first one of the segments responsive to the first one of the segments having weather susceptibility scores that are the most extreme scores of the segments. Responsive to the notification at 640 Responsive to the notification at 640, the computer system initiates a first action at 660 directed to the persons of a first one of the segments. The first action tends to affect the behaviors of the persons in the first one of the segments. Examples of first actions include notifying certain drivers, e.g., providing first electronic communications to the persons of the selected, first one of the segments; Increasing ER staff; and increasing food delivery staff.

At 670 the computer system may select a second one of the segments and performs a second action directed to the persons of a second one of the segments where the second action is different than the first action. For example, a second action may include notifying certain drivers, e.g., providing second electronic communications to the persons of the selected, second one of the segments, where the second electronic communications are different than the first electronic communications

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

One or more databases may be included in a host for storing and providing access to data for the various implementations. One skilled in the art will also appreciate that, for security reasons, any databases, systems, or components of the present invention may include any combination of databases or components at a single location or at multiple locations, wherein each database or system includes any of various suitable security features, such as firewalls, access codes, encryption, de-encryption and the like.

The database may be any type of database, such as relational, hierarchical, object-oriented, and/or the like. A database product that may be used to implement the databases is IBM® DB2®, or other available database products. (IBM and DB2 are trademarks of International Business Machines Corporation, registered in many jurisdictions worldwide.) The database may be organized in any suitable manner, including as data tables or lookup tables.

Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a key field in each of the manufacturer and retailer data tables. A key field partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

The host may provide a suitable website or other internet-based graphical user interface accessible by users. In one embodiment, Netscape web server, IBM® Websphere® Internet tools suite, an IBM DB2, universal database platform and a Sybase database platform are used in conjunction with a Sun Solaris operating system platform. (IBM and WebSphere are trademarks of International Business Machines Corporation, registered in many jurisdictions worldwide.) Additionally, components such as JBDC drivers, IBM connection pooling and IBM MQ series connection methods may be used to provide data access to several sources. The term webpage as it is used herein is not meant to limit the type of documents and application modules that might be used to interact with the user. For example, a typical website might include, in addition to standard HTML documents, various forms, Java applets, Javascript, active server pages (ASP), Java Server Pages (JSP), common gateway interface scripts (CGI), extensible markup language (XML), dynamic HTML, cascading style sheets (CSS), helper application modules, plug-ins, and the like.

While this specification contains many specifics, these should not be construed as limitations on the scope of the invention or of what can be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable sub combination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

The actions recited in the claims can be performed in a different order and still achieve desirable results. Likewise, the processes depicted in the accompanying figures do not necessarily require the particular order shown, or sequential order, to achieve desirable results. In certain implementations, multitasking and parallel processing can be advantageous.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, no element described herein is required for the practice of the invention unless expressly described as essential or critical.

The corresponding structures, materials, acts, and equivalents of all means or step plus function elements in the claims below are intended to include any structure, material, or act for performing the function in combination with other claimed elements as specifically claimed.

It should be appreciated that the particular implementations shown and described herein are illustrative of the invention and its best mode and are not intended to otherwise limit the scope of the present invention in any way. Other variations are within the scope of the following claims. Many modifications and variations will be apparent to those of ordinary skill in the art without departing from the scope and spirit of the invention. The embodiments presented herein were chosen and described in order to best explain the principles of the invention and the practical application and to enable others of ordinary skill in the art to understand the invention for various embodiments with various modifications as are suited to the particular use contemplated. The description of the present invention has been presented for purposes of illustration and description, but is not intended to be exhaustive or limited to the invention in the form disclosed.

What is claimed is:

1. A computer system implemented method for selectively responding to weather events, the method comprising:
receiving, by the computer system, indicia of behaviors of persons for a weather event;
determining, by the computer system, a weather susceptibility score for the persons responsive to the indicia of behaviors for the weather event of the persons;
classifying, by the computer system, the persons into segments based on the weather susceptibility scores, such that the persons in respectively different ones of the segments have respectively different behaviors for the weather event;
receiving, by the computer system, notification of the weather event;
selecting a first one of the segments; and
initiating, by the computer system responsive to the notification, a first action directed to the persons of the first one of the segments, where the first action tends to affect the behaviors of the persons in the first one of the segments.

2. The method of claim 1, where receiving indicia of behaviors of persons for a weather event comprises:
receiving attributes of persons that tend to indicate behaviors of the persons for the weather event.

3. The method of claim 1, where receiving indicia of behaviors of persons for a weather event comprises:
receiving observations of behaviors of the persons for the weather event.

4. The method of claim 1, where the received notification of the weather event comprises a received notification of a predicted occurrence of the weather event.

5. The method of claim 1, where the received notification of the weather event comprises a received notification of a presently occurring weather event.

6. The method of claim 1, where classifying the persons into segments comprises:
classifying such that the persons are in only one of the segments.

7. The method of claim 1, where the selecting the first one of the segments comprises:
selecting the first one of the segments responsive to the first one of the segments having weather susceptibility scores that are the most extreme scores of the segments.

8. The method of claim 1, where the differences of the respectively different behaviors include respective differences in degrees, such that the respectively different behaviors of the persons in respectively different ones of the segments include respectively different degrees of the same behaviors.

9. The method of claim 1, where performing a first action directed to the persons of the first one of the segments comprises:
providing first electronic communications to the persons of the selected, first one of the segments.

10. The method of claim 1 comprising:
selecting a second one of the segments; and
performing a second action directed to the persons of a second one of the segments where the second action is different than the first action.

11. The method of claim 1, where the recipients include customers and the segments include segments of the customers.

12. The method of claim 1, where the customers include prospective customers and the information included in the communications includes marketing information.

13. A system comprising:
a processor; and
a computer readable storage medium connected to the processor, where the computer readable storage medium has recorded thereon a program for controlling the processor, and where the processor is operative with the program to execute the program for:
receiving, by the computer system, indicia of behaviors of persons for a weather event;
determining, by the computer system, a weather susceptibility score for the persons responsive to the indicia of behaviors for the weather event of the persons;
classifying, by the computer system, the persons into segments based on the weather susceptibility scores, such that the persons in respectively different ones of the segments have respectively different behaviors for the weather event;
receiving, by the computer system, notification of the weather event;
selecting a first one of the segments; and
initiating, by the computer system responsive to the notification, a first action directed to the persons of a first one of the segments, where the first action tends to affect the behaviors of the persons in the first one of the segments.

14. The system of claim 13, where receiving indicia of behaviors of persons for a weather event comprises:
receiving attributes of persons that tend to indicate behaviors of the persons for the weather event.

15. The system of claim 13, where receiving indicia of behaviors of persons for a weather event comprises:
receiving observations of behaviors of the persons for the weather event.

16. The system of claim 13, where the received notification of the weather event comprises a received notification of a predicted occurrence of the weather event.

17. A computer program product, including a computer readable storage medium having instructions stored thereon for execution by a computer system, where the instructions, when executed by the computer system, cause the computer system to implement a method comprising:
receiving, by the computer system, indicia of behaviors of persons for a weather event;
determining, by the computer system, a weather susceptibility score for the persons responsive to the indicia of behaviors for the weather event of the persons;
classifying, by the computer system, the persons into segments based on the weather susceptibility scores, such that the persons in respectively different ones of the segments have respectively different behaviors for the weather event;
receiving, by the computer system, notification of the weather event;
selecting a first one of the segments; and
initiating, by the computer system responsive to the notification, a first action directed to the persons of a first one of the segments, where the first action tends to affect the behaviors of the persons in the first one of the segments.

18. The computer program product of claim 17, where classifying the persons into segments comprises:
classifying such that the persons are in only one of the segments.

19. The computer program product of claim 17, where the selecting the first one of the segments comprises:
selecting the first one of the segments responsive to the first one of the segments having weather susceptibility scores that are the most extreme scores of the segments.

20. The computer program product of claim 17, where the differences of the respectively different behaviors include respective differences in degrees, such that the respectively different behaviors of the persons in respectively different ones of the segments include respectively different degrees of the same behaviors.
